(19) United States
(12) Patent Application Publication
(10) Pub. No.: US 2015/0310450 A1
(43) Pub. Date: Oct. 29, 2015

(54) SYSTEMS AND METHODS FOR AWARDING GREEN SCORE TO BUSINESSES

(71) Applicant: Vivint, Inc., Provo, UT (US)

(72) Inventor: Greg Fairbanks, Cedar Hills, UT (US)

(73) Assignee: Vivint, Inc., Provo, UT (US)

(21) Appl. No.: 14/261,218

(22) Filed: Apr. 24, 2014

(51) Int. Cl. G06Q 30/00

(52) U.S. Cl. CPC G06Q 30/018

(57) ABSTRACT

Methods and systems are described for awarding a green score to a business using an automation and security system. According to at least one embodiment, an apparatus for awarding a green score to a business includes a processor, a memory in electronic communication with the processor, and instructions stored in the memory which are executable by a processor to receive data related to at least one of energy usage and energy conservation practices by a business, determine whether the energy usage by the business meets threshold levels, determine an energy green score for the business, and display the energy green score.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of home automation and security products. Advancements in mobile devices allow users to monitor and/or control an aspect of a home or business. As home automation and security products expand to encompass other systems and functionality in the home, opportunities exist for using the automation and security systems for alternative purposes such as tracking energy-related information about a home or business.

### SUMMARY

Methods and systems are described for awarding a green score to a business using an automation and security system. According to at least one embodiment, an apparatus for awarding a green score to a business includes a processor, a memory in electronic communication with the processor, and instructions stored in the memory which are executable by a processor to receive data related to at least one of energy usage and energy conservation practices by a business, determine whether the energy usage by the business meets threshold levels, determine an energy green score for the business, and display the energy green score.

In one embodiment, determining whether the energy usage by the business meets threshold levels includes comparing the energy usage to industry standards. The energy usage may include at least one of power consumption and fuel consumption. The energy conservation practices may include at least one of automated appliance controls, water consumption, energy certifications, green energy usage, and energy usage meters and/or sensors. The energy conservation practices may include changing energy usage depending on environmental conditions. The energy conservation practices may include achieving a percentage reduction in energy consumption. The instructions may be executable by the processor to compare the displayed energy green score to energy green scores of at least one other business, and display the compared energy green scores. Displaying the energy green score may include displaying on at least one social media site of the business. Displaying the energy green score may include displaying on a display screen on site at the business. The display screen may be part of a automation and security control panel.

Another embodiment is directed to a computer-program product for awarding a green score to a business. The computer-program product includes a non-transitory computer-readable medium storing instructions executable by a processor to receive data related to at least one of energy usage and energy conservation practices by a business, determine an energy green score for the business based on the received data, and display the energy green score.

In one embodiment, the instructions may be executable by the processor to compare the received data to industry standards. The instructions may be executable by the processor to display the energy green score at a location of the business. The instructions may be executable by the processor to automatically update the energy green score. Receiving data may include receiving the data at least monthly. Receiving data may include manually inputting at least some of the data by an employee of the business.

A further embodiment relates to a computer-implemented method for awarding a green score to a business. The method includes receiving data related to energy conservation practices by a business, determining an energy green score for the business based on the data, and displaying the energy green score.

In one embodiment, determining the energy green score may include determining whether energy usage by the business meets predetermined levels. Determining the energy green score may include determining a weighted value for each of the energy conservation practices. Displaying the energy green score may include displaying a color associated with the energy green score.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of another environment in which the present systems and methods may be implemented;

FIG. 3 is a block diagram of an example green score module of the environments shown in FIGS. 1 and 2;

FIG. 4 is a block diagram of an example display of the environment shown in FIGS. 1 and 2;

FIG. 5 is a flow diagram illustrating a method for awarding a green score to a business in accordance with the present disclosure;

FIG. 6 is a flow diagram illustrating another method for awarding a green score to a business in accordance with the present disclosure;

FIG. 7 is a flow diagram illustrating another method for awarding a green score to a business in accordance with the present disclosure; and

FIG. 8 is a block diagram of a computer system suitable for implementing the present systems and methods of FIGS. 1-7.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

At least some of the systems and methods described herein relate to automation and security systems for use in home, commercial and business settings. Some aspects of the present disclosure relate, more particularly, to energy usage and energy conservation practices for homes and/or businesses. For example, the systems and methods described herein may relate to generating a green score for a home or business. The green score may be displayed in any number of different ways so that those visiting the home or business, and/or comparing the green score or green practices of the home or business to other homes or businesses, have a relatively quick and easy indication of the green practices of that home or business.

The green score may be determined based on a variety of factors and may change depending on, for example, the settings, practices, operations, etc. for a home or business on any given day. For example, the green score may be based at least in part upon the total number of devices, systems, and/or methods used to monitor and/or limit the amount of energy used for a particular home or business. Other factors may include a percentage reduction in energy consumption within a given period of time. A further factor may include use of renewable energy sources. A still further factor may include the length of time in which green energy practices have been in place and sustained within a predetermine period of time. Other factors are described in detail below.

The factors considered as part of generating the green score may be weighted according to, for example, industry standards, standards established for a given climate or geographic area, or a customized set of standards for a particular type of home or business. The green score may be updated periodically such as, for example, on a minute, hourly, daily, weekly, monthly, or yearly basis. Alternatively, or additionally, the green score may be updated continuously in real time based on feedback from a variety of devices, sensors, systems, etc. associated with the home or business. In some arrangements, the green score may be calculated after manually entering data by persons associated with the home or business.

The green score may be displayed on location at the home or business. In at least one example, the green score is displayed on a control panel of a home automation and security system. Alternatively, or additionally, the green score may be displayed at other locations such as, for example, a digital sign dedicated to displaying the green score and positioned at a location in the home or place of business so that visitors may easily and readily observe the green score. In another example, the green score is displayed at a remote location such as on a display screen at a home office for a plurality of different places of business, on an internet website, broadcast on a television station, on a remote device such as tablet computer or smartphone, or any other medium in which a green score may be displayed.

The green score may be represented using, for example, alpha numeric characters, colors, symbols and/or logos, or some combination thereof. Various shapes, colors, characters, etc., may be used to represent various scores. In one example, different shades of the color green may be used with the darkest color of greens representing the highest green score and the lightest color of green representing the lowest green score. In another example, a scale of one to 10 may be used with the lowest numerals representing a low green score and higher numerals representing a higher green score. In still further examples, different sized and/or shaped versions of a given letter may be used, such as a lower case “g” for a low green score and an upper case “G” for a high green score. Many other options are possible for representing a green score to an observer.

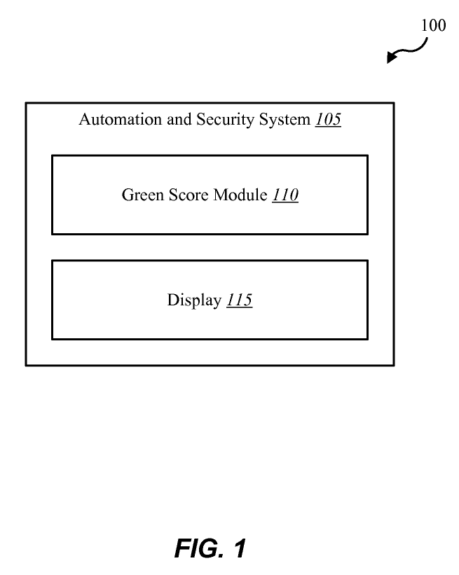

FIG. 1 is a block diagram illustrating one embodiment of an environment 100 in which the present systems and methods may be implemented. In some embodiments, the systems and methods described herein may be performed at least in part on or using an automation and security system 105. The environment 100 may include the automation and security system 105, a green score module 110, and a display 115. While FIG. 1 shows the green score module 110 and display 115 included within the automation and security system 105, these and other components of environment 100 may be housed separately and operable independent while still working cooperatively with each other and other components of automation and security system 105.

Green score module 110 may be configured to receive data related to energy saving and/or environmentally friendly practices for a home or business, and generate a green score for the home or business. The information received by green score module 110 that is used to generate the green score may be generally referred to as green score data. The green score data may be received from a variety of sources. These sources may provide information related to, for example, comprehensive energy usage for the home or business, energy usage of specific appliances or fixtures, thermostat data, fuel meter data, and usage of green energy devices such as solar panels, high efficiency devices, recycled materials, wind power, geothermal power, etc. The data used to generate the green score may be weighted according to, for example, categories such as energy usage, type of energy used, environmentally friendly practices, etc. The data may also be weighted based on, for example, industry standards and/or customizable standards established for particular types of homes or businesses. The data may also be weighted based on, at least in part, a duration of usage of a method, device, or standard, or a percentage improvement related to a particular parameter.

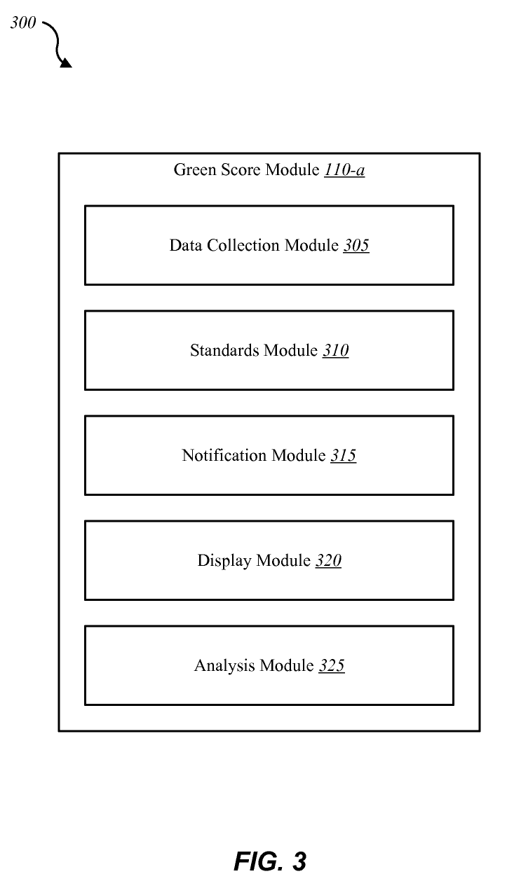

Green score module 110 may have the capability to store the data, analyze the data, create notifications related to the data, store criteria against which the data is evaluated, and other functions as described in further detail below with reference to FIG. 3. Green score module 110 may include the capability to generate a green score based on information collected solely by the automation and security system 105. Additionally, or alternatively, green score module 110 may also be capable of generating a green score and operating independent of automation and security system 105 and/or display 115. Green score module 110 may perform additional functions in response to instructions received from other systems and devices that are separate and independently operable from automation and security system 105 generally, or from particular components of automation and security system 105.

Display 115 may be configured to display and/or communicate in some manner the green score to a viewer. In one example, display 115 is a display screen of a control panel of automation and security system 105. In another example, display 115 includes a dedicated display screen or other device that is viewable within a home or business setting. Display 115 may also include a screen of a mobile device such as, for example, a laptop, tablet, smartphone, or other mobile computing device having a display screen. Display 115 may display the green score locally or remotely. For example, display 115 may provide viewing of the green score at a location remote from automation and security system 105 and/or at a location that is remote from the home or business premises.

Display 115 may also provide a user interface with automation and security system 105 and/or certain aspects of green score module 110. In one example, display 115 provides an interface for inputting at least some of the data used by green score module 110 to generate the green score. Display 115 may also display at least some of the data used by green score module 110. For example, display 115 may display a variety of parameters such as, for example, an on/off status of various appliances, electric power consumption, fuel consumption, status of temperature or other sensors, generation of renewable energy, etc. A user may interface with display 115 to select among various parameters that are considered by a green score module 110 to generate the green score. A user may interface with display 115 to select among a variety of ways to display the green score including, for example, a color code, alpha numeric characters, symbols, etc. The display may be displayed on display 115 itself and/or at other locations.

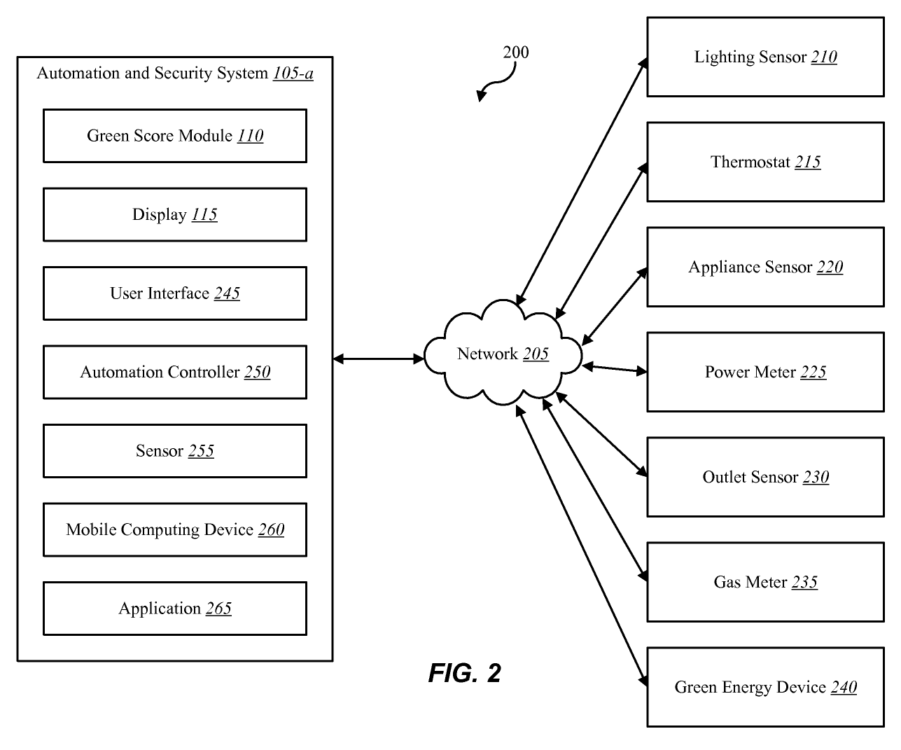

Referring now to FIG. 2, in some embodiments, an environment 200 may include the components of environment 100 described above, and may further include a network 205 and a plurality of devices and/or systems that generate data used by green score module 110 to create a green score. For example, environment 200 may include lighting sensor 210, thermostat 215, appliance sensor 220, power meter 225, outlet sensor 255, gas meter 235, and green energy device 240 (collectively referred to as green score devices), although additional or few devices and/or systems may be possible in this and other environments.

Automation and security system 105-a may be one example of automation and security system 105 described above with reference to FIG. 1. Automation and security system 105-a may include, in addition to green score module 110 and display 115, a user interface 245, an automation controller 250, a sensor 255, a mobile computing device 260, and an application 265. Automation and security system 105-a may include various components and functionality that work cooperatively with green score module 110 and display 115, and/or may operate independently of green score module 110 and display 115.

Lighting sensor 210 is one example of a green score device that provides green score data for use by green score module 110. Lighting sensor 210 may monitor an on/off state of any lighting associated with the home or business. For example, lighting sensor 210 may monitor an on/off state and/or power consumption of one or more lighting fixtures. The lighting fixtures may be positioned outside or inside of the home or business. Lighting sensor 210 may determine whether the lighting fixture includes an energy efficient fixture such as a halogen bulb, a lighting fixture that meets current high efficiency standards, or the like. A plurality of lighting sensors 210 may provide green score data for use by green score module 110 separately or in a consolidated manner. For example, lighting sensor 210 may indicate whether a certain percentage of the light fixtures being monitored include high energy bulbs, are in an on or an off state, or operate for a certain number of hours within a set time period (e.g., hours/day).

Thermostat 215 is another example of a green score device that provides green score data for use by green score module 110. Thermostat 215 may control operation of a heating and air condition (HVAC) system associated with the home or business. Thermostat 215 may monitor a temperature condition within an enclosed space or other area of a home or business. Thermostat 215 may confirm whether the temperature within the home or business is within a certain range or above or below a certain threshold. Thermostat 215 may include a thermometer that determines an indoor or outdoor temperature. Thermostat 215 may provide data related to relative temperatures between an interior and an exterior of the home or business.

Appliance sensor 220 is another example of a green score device that provides green score data for use by green score module 110. Appliance sensor 220 may monitor one or more appliances to determine an on/off state, energy usage, or other parameters associated with the appliance. For example, appliance sensor 220 may determine whether a given appliance meets certain energy efficiency standards. Appliance sensor 220 may also determine the total number of appliances that are operating at a given time, the total power consumption by the monitored appliances, etc. Appliance sensor 220 may monitor features of at least one appliance. For example, appliance sensor 220 may monitor an open/closed state of a refrigerator door or a window of the home or business, an on/off state of a ceiling fan, an off/off state of a water faucet, a water meter, or an internal temperature of a refrigerator or freezer.

Power meter 225 is another example of a green score device that provides green score data for use by green score module 110. Power meter 225 may provide data related to power consumption associated with at least some aspects of the home or business. For example, power meter 225 may determine a rate of power use, total power use, or power usage compared to other homes or businesses. Power meter 225 may provide data related to power usage of any appliance, fixture, device or system associated with the home or business. Power meter 225 may also provide data related to the source of the power (e.g., power drawn from a power grid or power generated by a renewable energy source (e.g., solar panels or wind turbines)).

Outlet sensor 255 is another example of a green score device that provides green score data for use by green score module 110. Outlet sensor 255 may be plugged into one or more outlets (e.g., sockets) at the home or place of business. Outlet sensor 255 may monitor the amount of energy (e.g., electricity) that is used at a particular outlet or socket, which may provide insight about the operation and/or efficiency of a device plugged in to the outlet. Information from outlet sensor 255 may be made available to green score module 110, or may be provided to power meter 225 before being provided to green score module 110.

Gas meter 235 is another example of a green score device that provides green score data for use by green score module 110 Gas meter 235 may monitor consumption of fuel such as, for example, natural gas or propane that is used in association with the home or business. Gas meter 235 may provide information related to total consumption of fuel or consumption of fuel by various appliances, devices or systems associated with the home or business. In one example, gas meter 235 monitors the amount of fuel consumed by an oven, hot water heater, or furnace of the home or business.

Green energy device 240 is another example of a green score device that provides green score data for use by green score module 110. Green energy device 240 may represent any number of different types of devices or systems. For example, green energy device 240 may be a renewable power generating device such as a wind turbine or a solar panel. Green energy device 240 may include a water metering device or an automatic on/off switch for an appliance that is programmed for a time of day, time of year, or day of week. Green energy device 240 may be any device that provides an advantage related to reduced consumption of energy or an environmentally friendly alternative or practice associated with the home or business. Green energy device 240 may include an existing device that is used in an environmentally responsible or advantageous way, such as a way that reduces energy consumption.

At least some aspects of green score module 110 and display 115 may be integrated with other components and functionality of automation and security system 105-a. For example, user interface 245 may be integrated into an existing control panel of automation and security system 105. The control panel may include a user interface for controlling other features of automation and security system 105-a such as, for example, alarm systems, sensor activation, light controls, appliance controls, thermostat controls, etc. User interface 245 may include a display (e.g., display 115), actuation buttons and other control features of a control panel of the automation and security system 105-a. Alternatively, or additionally, user interface 245 may be a separate component from the control panel of the automation and security system 105-a and may be located at any desired location relative to a place of business, property, or the like that is monitored by the automation and security system 105-a. User interface 245 may be available at a plurality of locations such as, for example, any of several control panels of automation and security system 105-a, or a remote device such as a tablet computer, desktop computer, smartphone, or the like that is positioned remote from the home or place of business being monitored by automation and security system 105-a.

Automation controller 250 may provide at least some automated control of various features of automation and security system 105-a. One such automated control feature may be to automatically carry out various tasks in response to green score data collected and/or analyzed by green score module 110. In one embodiment, automation controller 250 turns off building lights, reduces a thermostat setting, or turns on a security feature of automation and security system 105-a at a predetermined time.

Sensor 255 shown in FIG. 2 may represent one or more separate sensors or a combination of two or more sensors in a single sensor device. For example, sensor 255 may represent one or more camera sensors and one or more motion sensors connected to or a part of automation and security system 105-a. Additionally, or alternatively, sensor 255 may represent a combination sensor such as both a camera sensor and a motion sensor integrated into the same sensor device. Although sensor 255 is depicted as connecting to or a part of automation and security system 105-a, in some embodiments, sensor 255 may be dedicated exclusively to the green score module 110, or may be operable independent of and separately from any functionality of green score module 110. Sensor 255 may include an accelerometer to enable sensor 255 to detect movement (e.g., opening or closing of a door or window, or operation of an appliance or machinery). Sensor 255 may include a wireless communication device enabling sensor 255 to read and receive data and/or information to and from one or more devices in environment 200 (e.g., green score module 110). Additionally, or alternatively, sensor 255 may include a GPS sensor to enable sensor 255 to track a location of sensor 255. Sensor 255 may include a proximity sensor to enable sensor 255 to detect proximity of a user or appliance relative to a predetermined distance from a dwelling (e.g., inside or outside a building or perimeter of a place of business). Sensor 255 may include one or more security detection sensors such as, for example, a glass break sensor or a motion detection sensor. Additionally, or alternatively, sensor 255 may include a smoke detection sensor, a carbon monoxide sensor, a fire detection sensor, or some combination thereof.

The green score data described herein may include data collected by sensor 255. In some embodiments, mobile computing device 260 may include one or more processors, one or more memory devices, and/or a storage device. Examples of mobile computing device 260 may include mobile computing devices, smartphones, personal computing devices, computers, servers, etc. Mobile computing device 260 may be operable independent of features of green score module 110 and display 115. Alternatively, at least some functionality of mobile computing device 260 may cooperate with and/or interface with green score module 110, display 115, and/or any of the green score device described with reference to FIG. 2.

Application 265 may allow a user to control (either directly or via automation controller 250) an aspect of the monitored property, including security, energy management, locking or unlocking a door, checking the status of a door, locating a user or item, controlling lighting, thermostat, cameras, receiving notification regarding a current status or anomaly associated with a home, office, place of business, and the like. In some configurations, application 265 may enable automation and security system 105-a to interface with automation controller 250 and/or a green score module 110 and display automation, security, and/or energy management content on, for example, green score module 110, user interface 245, or mobile computing device 260. Thus, application 265, via the user interface 245 or other feature of automation and security system 105-a, may allow users to control aspects of their home, office, and/or other type of property (e.g., place of business). Further, application 265 may be installed on mobile computing device 260 in order to allow a user to interface with a function of automation and security system 105-a or automation controller 250. Information or data associated with application 265 and its operation may be saved according to the data storage methods described herein.

In some embodiments, a user may access the functions of automation and security system 105-a from mobile computing device 260. For example, in some embodiments, mobile computing device 260 includes a mobile application that interfaces with one or more functions of automation and security system 105-a (e.g., green score module 110). Examples of automation controller 250 may include a dedicated automation computing device (e.g., wall-mounted controller), a personal computing device (e.g., a laptop, desktop, etc.), a mobile computing device (e.g., tablet computing device, smartphone, etc.), and the like. Green score module 110 and/or user interface 245 may be integrated with automation controller 250 in the form of one or more personal computing devices (e.g., mobile devices, smartphones, and/or personal computing devices) to both control aspects of the property and receive and display notifications regarding the activity of a property, in particular as it relates to generation of a green score.

Lighting sensor 210, thermostat 215, appliance sensor 220, power meter 225, outlet sensor 255, gas meter 235, and green energy device 240 (generally be referred to as green score devices) may communicate with green score module 110 and other features and components of automation and security system 105-a via, for example, network 205. The green score devices, although specifically identified in FIG. 2 as lighting sensor 210, thermostat 215, appliance sensor 220, power meter 225, outlet sensor 255, gas meter 235, and green energy device 240, may be any of a variety of electronic devices including, for example, a dedicated automation computing device (e.g., wall-mounted controller), a personal computing device (e.g., laptop, desktop, etc.), a mobile computing device (e.g., a tablet computing device, smartphone, etc.), and the like. The green score devices may be located physically away from automation and security system 105-a or components thereof such as, for example, display 115. The green score devices may be accessed by, for example, an owner of the home or place of business, manager, supervisor, or other personnel associated with the place of business. The green devices may be configured for two-way communication with green score module 110 and other features of automation and security system 105-a.

The green devices may include a user interface, storage capability, and other features and functionalities that permit the green devices to not only receive notifications and data, but to also send instructions, data, notifications, and the like. The green devices may generate data related to operation of a particular green device, or data related to the system and/or device being monitored by the green device. The green devices may store the data (e.g., in a database (not shown)), and send notifications to green score module 110 or other components of automation and security system 105-a.

Network 205 provides communication via, for example, wired or wireless connections. Further, network 205 may include a plurality of communication mediums. For example, network 205 may include different communication mediums to provide communication between green score module 110 and/or other components of automation and security system 105-a, and other devices such as the green devices discussed above. Examples of network 205 include cloud networks, local area networks (LAN), wide area networks (WAN), virtual private networks (VPN), wireless networks (using 802.11, for example) and/or cellular networks (using 3G and/or LTE, for example), etc. In some embodiments, network 205 may include the internet.

FIG. 3 is a block diagram 300 illustrating one example of green score module 110-a. Green score module 110-a may be one example of green score module 110 depicted in FIGS. 1 and/or 2. As depicted, green score module 110-a may include a data collection module 305, a standards module 310, a notification module 315, a display module 320, and an analysis module 325. Other embodiments may include more or fewer of the modules shown in FIG. 3.

Data collection module 305 may receive and/or acquire data from any of the green data devices described above with reference to FIG. 2. The green data may be collected, store, and delivered to other components or features of green score module 110-a. Data collection module 305 may acquire green data by manual input by a user. Alternatively, data collection module may automatically collect or receive green data periodically or in real time.

Standards module 310 may store one or more standards to which the green data is compared as part of determining a green score. Standards module 310 may include a data base of standards. The standards may be updated automatically. Standards module 310 may be connected to sources of information via, for example, network 205 (e.g., the internet) and updated automatically. The standards against which the green data is compared may be industry related standards, or standards associated with a particular climate, geographic area, dwelling size or type of dwelling, type of business, or business activity associated with a place of business. In one example, a standard is based on the amount of energy consumption associated with a building of certain square footage. Another standard may be associated with the type of appliances recommended for a particular type of business activity.

Notification module 315 may be operable to provide notifications related to the green data collected by a data collection module 305 and/or comparison of the green data to standards associated with standards module 310. Notification module 315 may be provide notifications in a variety of formats including, for example, audio messages, text messages, and visual indicators such as flashing or colored lights, etc. Notification module 315 may be in communication with display 115 and/or display module 320.

Display module 320 may provide communication with display 115 or other devices and systems used to display information related to the green data, green score, or green devices discussed above with reference to FIG. 2. Display module 320 may provide formatting of information and/or data from green score module 110 for display in any manner. In at least one example, green score module 110 may include a separate display from display 115, and display module 320 may provide a medium for displaying at least some information related to the green score.

Analysis module 325 may provide at least some analysis of the green data collected by data collection module 305. For example, analysis module 325 may compare the green data to at least one standard stored in standards module 310. Analysis module 325 may provide other analysis such as, for example, comparison of past green data to current green data, projection of energy usage based on current green data, and recommendations for change of practices for improved energy consumption and/or environmentally friendly activities to obtain or reach a certain green standard or obtain a desired green score.

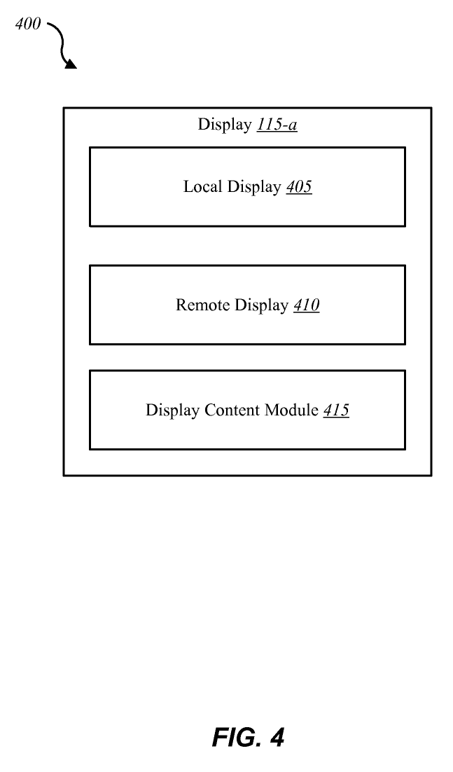

FIG. 4 is a block diagram 400 illustrating an example display 115-a. Display 115-a may be one example of display 115 depicted in FIGS. 1 and/or 2. As depicted, display 115-a may include a local display 405, a remote display 410, and a display content module 415.

Local display 405 may include a device for displaying a green score or other information associated with the green score. For example, local display 405 may include a digital screen (e.g., a touch screen) that displays the green score. In one example, local display 405 includes a display screen on a control panel of the automation and security system 105 described herein. Alternatively, or additionally, local display 405 may include one or more light generating devices, or a sound generating device. Local display 405 may include a plurality of display devices that are viewable on the premise of the home or business.

Remote display 410 may include any of the same display features and functionality of local display 405. Remote display 410 may display the green score and/or associated green score data at a location remote from the property, device, or location for which the green score is generated. Remote display 410 may be associated with a mobile device. Remote display 410 may include a dashboard upon which a plurality of green scores associated with a plurality of different homes and/or businesses is displayed.

Display content module 415 may determine how a green score and/or green data is displayed. Display content module 415 may provide a plurality of options for a user to select from for how the green score or green data is displayed. Display content module 415 may operate to distinguish between a variety of different green scores and/or green data and determine whether that content should be displayed locally on local display 405 or remotely on remote display 410. Display content module 415 may operate based on parameters that are preset and/or modified by a user locally or remotely.

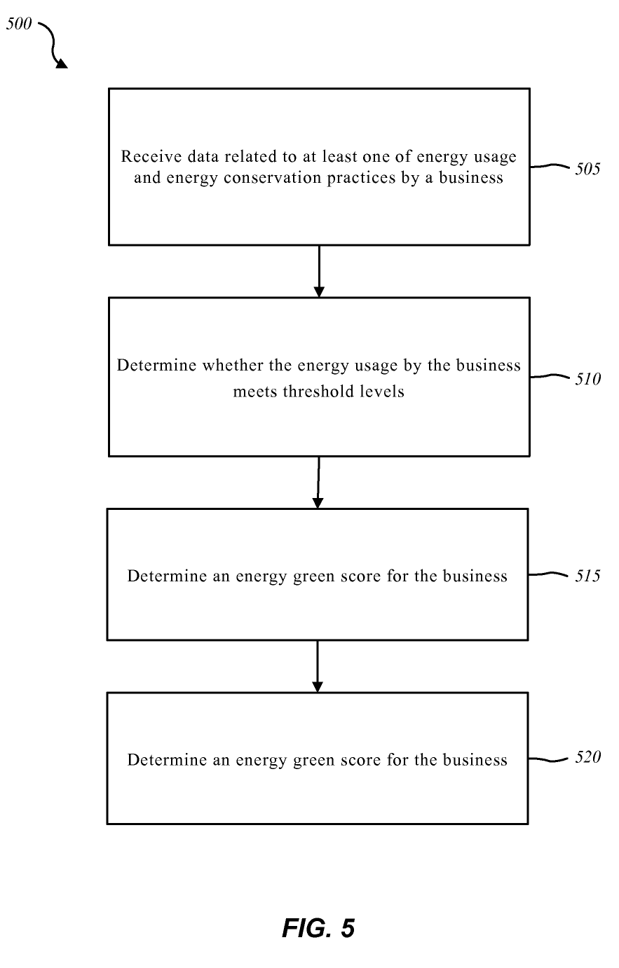

FIG. 5 is a flow diagram illustrating one embodiment of a method 500 for awarding a green score to a home or business. In some configurations, the method 500 may be implemented by the green score module 110 of the automation and security system 105 shown in FIGS. 1 and 2. In other examples, method 500 may be performed generally by automation and security system 105 shown in FIGS. 1 and/or 2, or even more generally by the environments 100, 200 shown in FIGS. 1 and/or 2.

At block 505, the method 500 includes receiving data related to at least one of energy usage and energy conservation practices by a business. Block 510 includes determining whether the energy usage by the business meets threshold levels. Block 515 includes determining an energy green score for the business. At block 520, the method 500 includes determining an energy green score for the business.

Other steps of method 500 may include comparing the energy usage to industry standards as part of determining whether the energy usage by the business meets threshold levels. The energy usage may include at least one of power consumption and fuel consumption. The energy conservation practices may include at least one of automated appliance controls, water consumption, energy certifications, green energy usage, and energy usage meters and sensors. The energy conservation practices, additionally or alternatively, may include changing energy usage depending upon environmental conditions. The energy conservation practices, alternatively or additionally, may include achieving a percentage reduction in energy consumption. The method 500 may also include comparing the displayed energy green score to energy green scores of at least one other business, and displaying the compared energy green scores. Displaying the energy green score may include displaying on at least one social media site of the business. Displaying the energy green score may include displaying on a display screen on site at the business. The display screen may be part of an automation and security control panel.

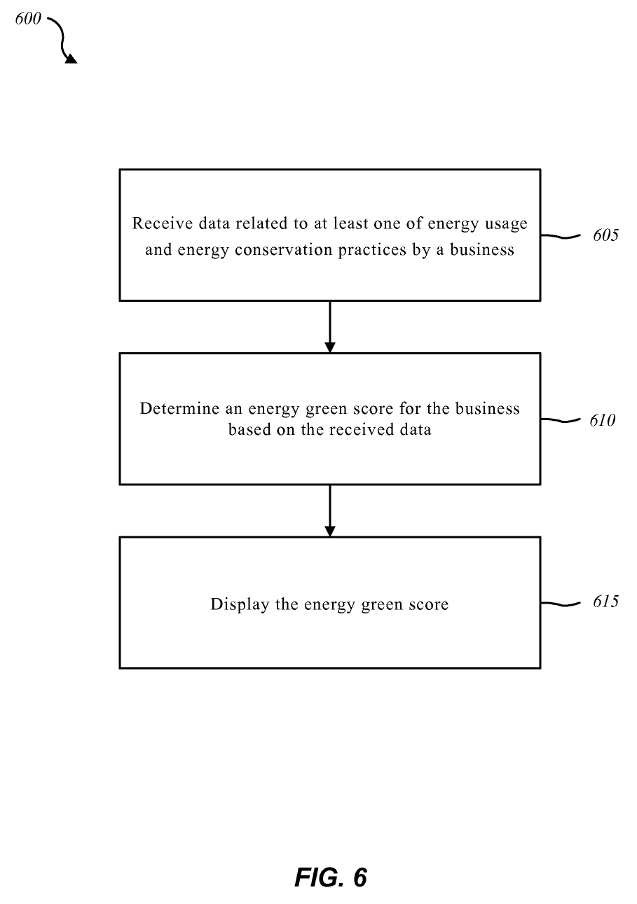

FIG. 6 is a flow diagram illustrating one embodiment of a method 600 for awarding a green score to a home or business. In some configurations, the method 600 may be implemented by the green score module 110 of the automation and security system 105 shown in FIGS. 1 and 2. In other examples, method 600 may be performed generally by automation and security system 105 shown in FIGS. 1 and/or 2, or even more generally by the environments 100, 200 shown in FIGS. 1 and/or 2.

At block 605, method 600 includes receiving data related to at least one of energy usage and energy conservation practices by a business. Block 610 includes determining an energy green score for the business based on the received data. At block 615, the method 600 includes displaying the energy green score.

Other steps of method 600 may include comparing the received data to industry standards. The method 600 may also include displaying the energy green score at a location of the business. The method 600 may also include automatically updating the energy green score. Receiving the data may include receiving the data at least monthly. Receiving the data may include manually inputting at least some of the data by an employee of the business.

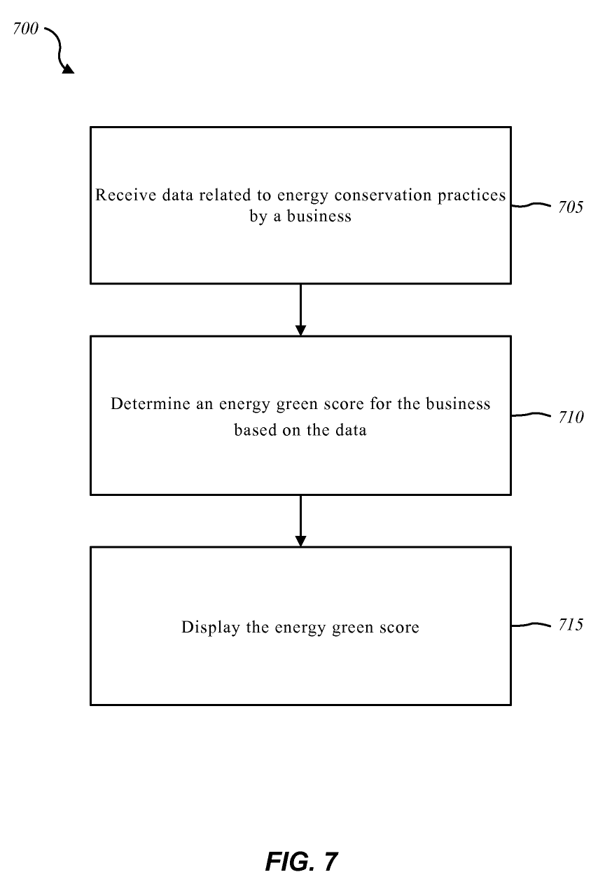

FIG. 7 is a flow diagram illustrating one embodiment of a method 700 for awarding a green score to a home or business. In some configurations, the method 700 may be implemented by the green score module 110 of the automation and security system 105 shown in FIGS. 1 and 2. In other examples, method 700 may be performed generally by automation and security system 105 shown in FIGS. 1 and/or 2, or even more generally by the environments 100, 200 shown in FIGS. 1 and/or 2.

At block 705, method 700 includes receiving data related to energy conservation practices by a business. Block 710 includes determining an energy green score for the business based on the data. Block 715 includes displaying the energy green score.

Other steps of method 700 may include determining whether energy usage by the business meets predetermined levels as part of determining the energy green score. The method may include determining a weighted value for each of the energy conservation practices as part of determining the energy green score. Method 700 may include displaying a color associated with the energy green score as part of displaying the energy green score.

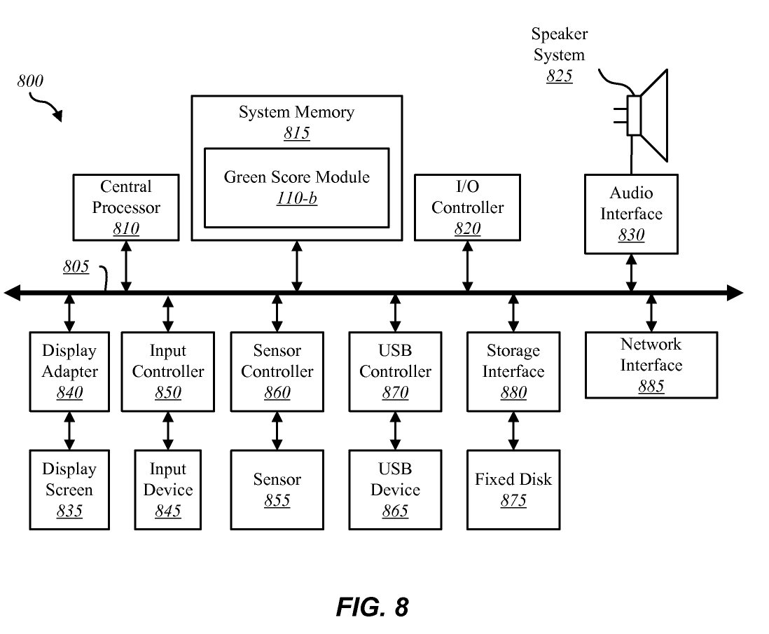

FIG. 8 depicts a block diagram of a controller 800 suitable for implementing the present systems and methods. In one configuration, controller 800 includes a bus 805 which interconnects major subsystems of controller 800, such as a central processor 810, a system memory 815 (typically RAM, but which may also include ROM, flash RAM, or the like), an input/output controller 820, an external audio device, such as a speaker system 825 via an audio output interface 830, an external device, such as a display screen 835 via display adapter 840, an input device 845 (e.g., remote control device interfaced with an input controller 850), multiple USB devices 865 (interfaced with a USB controller 870), and a storage interface 880. Also included are at least one sensor 855 connected to bus 805 through a sensor controller 860 and a network interface 885 (coupled directly to bus 805).

Bus 805 allows data communication between central processor 810 and system memory 815, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the green score module 110-b to implement the present systems and methods may be stored within the system memory 815. Applications resident with controller 800 are generally stored on and accessed via a non-transitory computer readable medium, such as a hard disk drive (e.g., fixed disk 875) or other storage medium. Additionally, applications can be in the form of electronic signals modulated in accordance with the application and data communication technology when accessed via interface 885.

Storage interface 880, as with the other storage interfaces of controller 800, can connect to a standard computer readable medium for storage and/or retrieval of information, such as a fixed disk drive 875. Fixed disk drive 875 may be a part of controller 800 or may be separate and accessed through other interface systems. Network interface 885 may provide a direct connection to a remote server via a direct network link to the Internet via a POP (point of presence). Network interface 885 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 800 wirelessly via network interface 885.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 8 need not be present to practice the present systems and methods. The devices and subsystems can be interconnected in different ways from that shown in FIG. 8. The aspect of some operations of a system such as that shown in FIG. 8 are readily known in the art and are not discussed in detail in this application. Code to implement the present disclosure can be stored in a non-transitory computer-readable medium such as one or more of system memory 815 or fixed disk 875. The operating system provided on controller 800 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An apparatus for awarding a green score to a business, comprising:
a processor;
a memory in electronic communication with the processor; and
instructions stored in the memory, the instructions being executable by a processor to:
receive data related to at least one of energy usage and energy conservation practices by a business;
determine whether the energy usage by the business meets threshold levels;
determine an energy green score for the business based at least in part on the threshold determination; and
display the energy green score.

2. The apparatus of claim 1, wherein determining whether the energy usage by the business meets threshold levels includes comparing the energy usage to industry standards.

3. The apparatus of claim 1, wherein energy usage includes at least one of power consumption and fuel consumption.

4. The apparatus of claim 1, wherein the energy conservation practices include at least one of automated appliance controls, water consumption, energy certifications, green energy usage, and energy usage meters and sensors.

5. The apparatus of claim 1, wherein the energy conservation practices include changing energy usage depending on environmental conditions.

6. The apparatus of claim 1, wherein the energy conservation practices include achieving a percentage reduction in energy consumption.

7. The apparatus of claim 1, wherein the instructions are executable by the processor to:
compare the displayed energy green score to energy green scores of at least one other business; and
display the compared energy green scores.

8. The apparatus of claim 1, wherein displaying the energy green score includes displaying on at least one social media site of the business.

9. The apparatus of claim 1, wherein displaying the energy green score includes displaying on a display screen on site at the business.

10. The apparatus of claim 9, wherein the display screen is part of a automation and security control panel.

11. A computer-program product for awarding a green score to a business, the computer-program product comprising a non-transitory computer-readable medium storing instructions executable by a processor to:
receive data related to at least one of energy usage and energy conservation practices by a business;
determine an energy green score for the business based on the received data; and
display the energy green score.

12. The computer-program product of claim 11, wherein the instructions are executable by the processor to:
compare the received data to industry standards.

13. The computer-program product of claim 11, wherein the instructions are executable by the processor to:
display the energy green score at a location of the business.

14. The computer-program product of claim 11, wherein the instructions are executable by the processor to:
automatically update the energy green score.

15. The computer-program product of claim 11, wherein receiving the data includes receiving the data at least monthly.

16. The computer-program product of claim 11, wherein receiving data includes manually inputting at least some of the data by an employee of the business.

17. A computer-implemented method for awarding a green score to a business, comprising:
receiving data related to energy conservation practices by a business;
determining an energy green score for the business based on the data; and
displaying the energy green score.

18. The method of claim 17, wherein determining the energy green score includes determining whether energy usage by the business meets predetermined levels.

19. The method of claim 17, wherein determining the energy green score includes determining a weighted value for each of the energy conservation practices.

20. The method of claim 17, wherein displaying the energy green score includes displaying a color associated with the energy green score.
